(19) United States
(12) Patent Application Publication
(10) Pub. No.: US 2013/0215223 A1
(43) Pub. Date: Aug. 22, 2013

(54) IMAGE PROCESSING APPARATUS AND METHOD FOR CONTROLLING THE SAME

(71) Applicant: CANON KABUSHIKI KAISHA, (US)

(72) Inventor: Shigeki Mochizuki, Kawasaki-shi (JP)

(73) Assignee: CANON KABUSHIKI KAISHA, Tokyo (JP)

(21) Appl. No.: 13/758,123

(22) Filed: Feb. 4, 2013

(30) Foreign Application Priority Data
Feb. 16, 2012 (JP) 2012-031815

(51) Int. Cl. H04N 13/00

(52) U.S. Cl. CPC H04N 13/0048
USPC 348/43

(57) ABSTRACT

An image processing apparatus which generates an encoding parameter for encoding multi-viewpoint moving image data in accordance with a first encoding method and encodes the multi-viewpoint moving image data in accordance with the generated encoding parameter and the first encoding method, generates an encoding parameter used for encoding the multi-viewpoint moving image data by the first encoding unit such that the encoding parameter used for encoding the multi-viewpoint moving image data is usable to encode, in accordance with a second encoding method different from the first encoding method, moving image data obtained by reducing the number of horizontal pixels in each of left and right eye images in the multi-viewpoint moving image data and combining the left and right eye images, in each of which the number of pixels is reduced.

### BACKGROUND OF THE INVENTION

1. Field of the Invention

The present invention relates to an image processing apparatus, and particularly to an image processing apparatus provided with an image data encoding function.

2. Description of the Related Art

Conventionally, an apparatus is known which photographs a three-dimensional (multi-viewpoint) image including a left eye image and a right eye image, and records the images in a recording medium. The MPEG4 AVC method is conventionally known as a method of encoding moving image data. In addition, in order to encode multi-viewpoint image data, MPEG4 MVC is proposed which is an extended standard of MPEG4 AVC. The method proposed in MPEG4 MVC uses a prediction encoding method of motion compensation and parallax compensation, and encodes each of the left eye image and the right eye image (for instance, refer to Japanese Patent Application Laid-Open No. 2011-087195).

On the other hand, such a configuration is also considered as to decrease the number of pixels in a horizontal direction of each of the left eye image and the right eye image to a half, generate two-dimensional image data of a side-by-side method of converting the left eye image and the right eye image to one picture by arranging those images side by side, encode the two-dimensional image data by a motion compensation prediction encoding method, and record the encoded data. As an encoding method at this time, MPEG4 AVC can be used.

In the side-by-side method, the number of pixels in the horizontal direction of each of the left eye image and the right eye image is reduced into a half. Accordingly, the number of pixels in each of the left eye image and the right eye image is increased at the time of reproduction by interpolation or the like, and the image data is restored. Because of this, an image quality of a restored image deteriorates.

In contrast to this, when multi-viewpoint image data is encoded in accordance with MPEG4 MVC, there is no need to reduce the number of pixels in the left eye image and the right eye image. Because of this, from a viewpoint of an image quality, it is preferable to use a multi-viewpoint image encoding method which encodes each of the left eye image and the right eye image.

However, in an apparatus which cannot decode moving image data encoded by the MPEG4 MVC, moving image data encoded by the multi-viewpoint image encoding method cannot be decoded. Therefore, only a two-dimensional image of any one of the left eye image or the right eye image can be decoded.

Then, it is desirable to be capable of simply converting moving image data encoded by the multi-viewpoint image encoding method into a moving image of the side-by-side method, and encoding the moving image.

### SUMMARY OF THE INVENTION

It is an aspect of the invention to solve such a problem, and to efficiently convert the moving image data which is encoded by a multi-viewpoint image encoding method into the side-by-side image at high speed, and to attain to encode the side-by-side image.

In order to solve the above described object of the present invention, an image processing apparatus according to the present invention includes a parameter generation unit configured to generate an encoding parameter for encoding, in accordance with a first encoding method, multi-viewpoint moving image data including left eye moving image data and right eye moving image data, a first encoding unit configured to encode the multi-viewpoint moving image data using the encoding parameter generated by the parameter generation unit in accordance with the first encoding method, and a control unit configured to control the parameter generation unit to generate an encoding parameter used for encoding the multi-viewpoint moving image data by the first encoding unit such that the encoding parameter used for encoding the multi-viewpoint moving image data can be used to encode, in accordance with a second encoding method different from the first encoding method, converted moving image data obtained by reducing the number of horizontal pixels in each of a left eye image and a right eye image in the multi-viewpoint moving image data and combining the left eye image and the right eye image, in each of which the number of pixels is reduced.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image processing system according to a first embodiment of the present invention.

FIG. 2 is a view conceptually illustrating an encoding method of multi-viewpoint moving image data.

FIG. 3 is a view illustrating a relationship between a multi-viewpoint image and a side-by-side image according to an exemplary embodiment of the present invention.

FIGS. 4A, 4B and 4C are views illustrating a macro block division type concerning moving image encoding.

FIG. 5 is a view illustrating a flow chart of encoding processing according to the first embodiment of the present invention.

FIG. 6 is comprised of FIGS. 6A and 6B, showing a view illustrating a flow chart of encoding processing of a transposing mode according to the first embodiment of the present invention.

FIG. 7 is a view illustrating a flow chart of encoding processing of a normal mode according to the first embodiment of the present invention.

FIG. 8 is a view illustrating a flow chart of conversion processing according to the first embodiment of the present invention.

FIGS. 9A and 9B are conceptual views of conversion processing of a macro block division type according to an exemplary embodiment of the present invention.

FIGS. 10A, 10B and 10C are conceptual views of the conversion processing of the macro block division type according to an exemplary embodiment of the present invention.

FIG. 11 is a conceptual view of conversion processing of a motion vector according to an exemplary embodiment of the present invention.

FIG. 12 is a conceptual view of conversion processing of a parallax vector according to an exemplary embodiment of the present invention.

FIG. 13 is a block diagram illustrating an image processing apparatus according to a second embodiment of the present invention.

### DESCRIPTION OF THE EMBODIMENTS

Exemplary embodiments of the present invention will now be described in detail in accordance with the accompanying drawings.

### First Embodiment

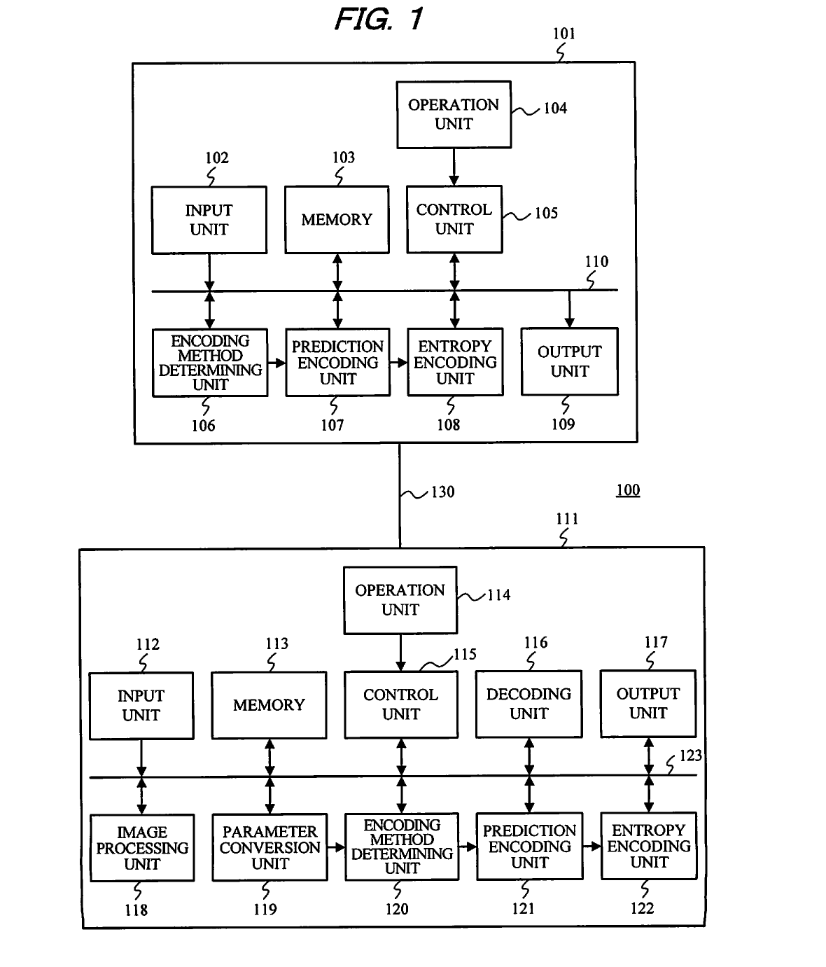

FIG. 1 is a block diagram illustrating a configuration of an image processing system 100 according to a first embodiment of the present invention. The image processing system 100 of FIG. 1 includes an image processing apparatus 101 which encodes multi-viewpoint moving image data including right eye moving image data and left eye moving image data in accordance with a multi-viewpoint image encoding method such as MPEG4 MVC. The image processing system 100 also includes an image processing apparatus 111 which decodes the multi-viewpoint moving image data that is encoded by the image processing apparatus 101, and converts the decoded multi-viewpoint moving image data into side-by-side moving image data. The image processing apparatus further encodes this converted moving image data in accordance with MPEG4 AVC.

Firstly, the image processing apparatus 101 will be described below.

An input unit 102 inputs the multi-viewpoint moving image data which includes the right eye moving image data and the left eye moving image data, and stores the data which is input in a memory 103 through a bus 101. The input unit 102 can input multi-viewpoint moving image data which is photographed by a video camera, for instance. The memory 103 stores the input moving image data and various information therein. An operation unit 104 has a power source switch, a switch for directing to start or stop encoding processing, a switch for switching between a transposing mode and a normal mode processing which will be described later, and the like. A control unit 105 has a not-shown CPU (microcomputer), a memory and the like, and controls the operation of the image processing apparatus 101 in response to the direction from the operation unit 104, in accordance with software stored in the memory. An encoding method determining unit 106 determines, according to the set mode, a parameter such as a slice type, a macro block division type, a prediction encoding mode and the like, to be used when the multi-viewpoint moving image data is encoded. A prediction encoding unit 107 generates prediction error data of the multi-viewpoint moving image data according to an encoding parameter which is determined by the encoding method determining unit 106, and generates data which is obtained by orthogonally transforming the generated prediction error data. An entropy encoding unit 108 performs entropy encoding processing to the data sent from the prediction encoding unit 107. An output unit 109 outputs the encoded multi-viewpoint moving image data to an external apparatus which includes the image processing apparatus 111, through a transmission path 130 such as a wired transmission path, a wireless transmission path or the like.

In MPEG4 MVC, an image of each viewpoint is defined as a view component, and a plurality of the view components constitute multi-viewpoint encoded data. The view component needs to definitely include a view component which is encoded in accordance with the MPEG4 AVC method and can be decoded by itself. This view component is referred to as a base view, and other view component is referred to as a non-base view. The base view cannot be encoded using a parallax compensation prediction which uses an image of a viewpoint other than that of the base view itself as a reference picture, and can be encoded only by an intra-picture prediction or an inter-picture prediction which uses a picture of the viewpoint of the base view itself as the reference picture. The non-base view can be encoded using the intra-picture prediction or the inter-picture prediction which uses the picture of the viewpoint of the base view itself as the reference picture, as well as, a parallax compensation prediction which uses a picture of a viewpoint other than that of the non-base view itself as the reference picture. In the present exemplary embodiment, the left eye image shall be the base view, and the right eye image shall be the non-base view.

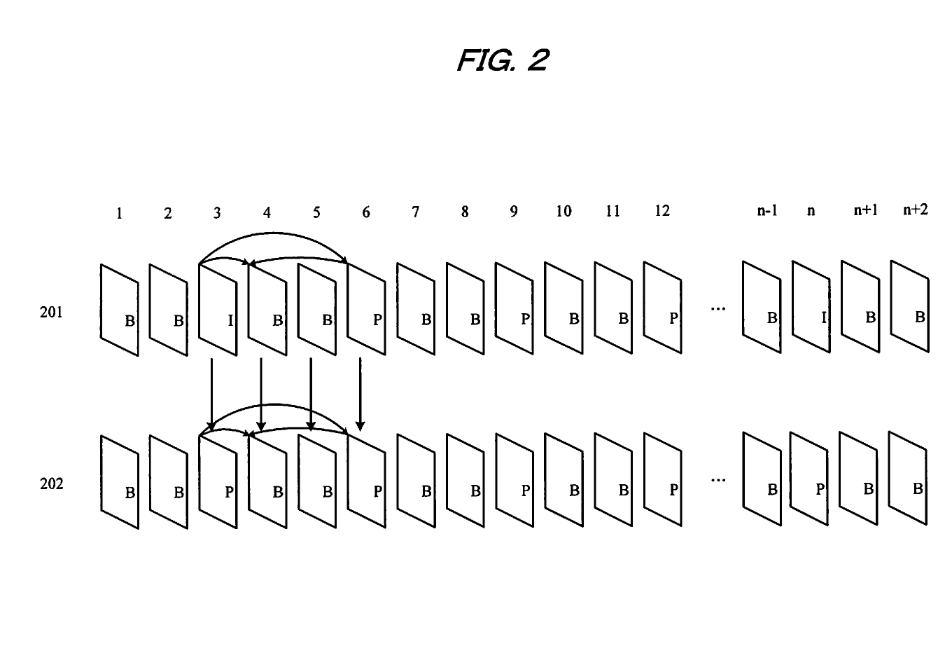

FIG. 2 conceptually illustrates an encoding method of the multi-viewpoint moving image data. The multi-viewpoint moving image data includes left eye moving image data 201 and right eye moving image data 202. As is described above, the left eye moving image data 201 is the base view, and the right eye moving image data 202 is the non-base view. Incidentally, the numbers 1, 2, . . . , and (n+2) described in FIG. 2 denote the order of display of each picture.

I, P and B described in FIG. 2 represent an I slice, a P slice and a B slice, respectively. Because the left eye moving image data 201 is the base view, the I slice is encoded by the intra-picture prediction, the P slice is encoded by a forward prediction which uses a forward picture as a reference picture, and the B slice is encoded by a bidirectional prediction which uses forward and backward pictures as a reference picture.

In addition, because the right eye moving image data 202 is the non-base view, the P and B slices can be encoded by using prediction encoding by a parallax prediction which uses the left eye image of the same time point as the right eye image as a reference picture, in addition to the forward prediction and the bidirectional prediction, respectively.

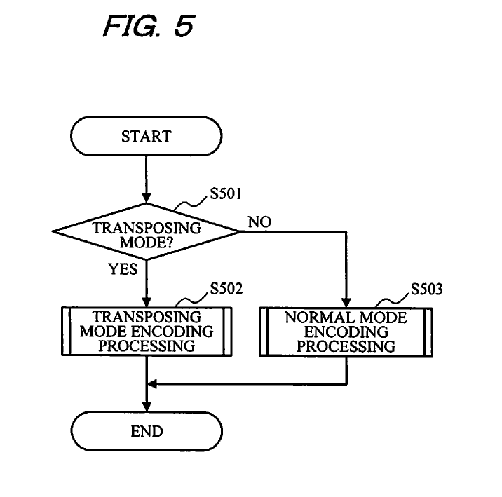

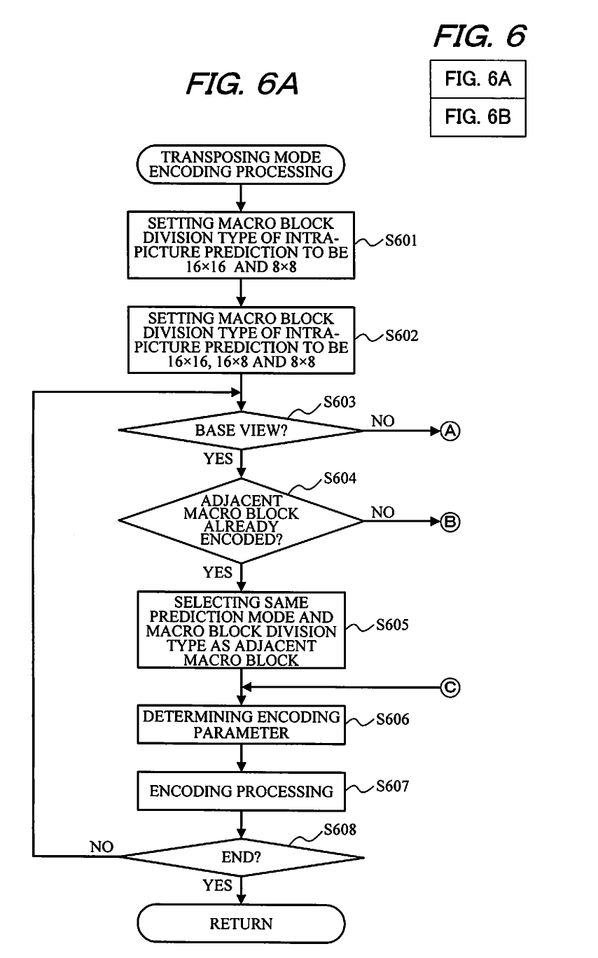

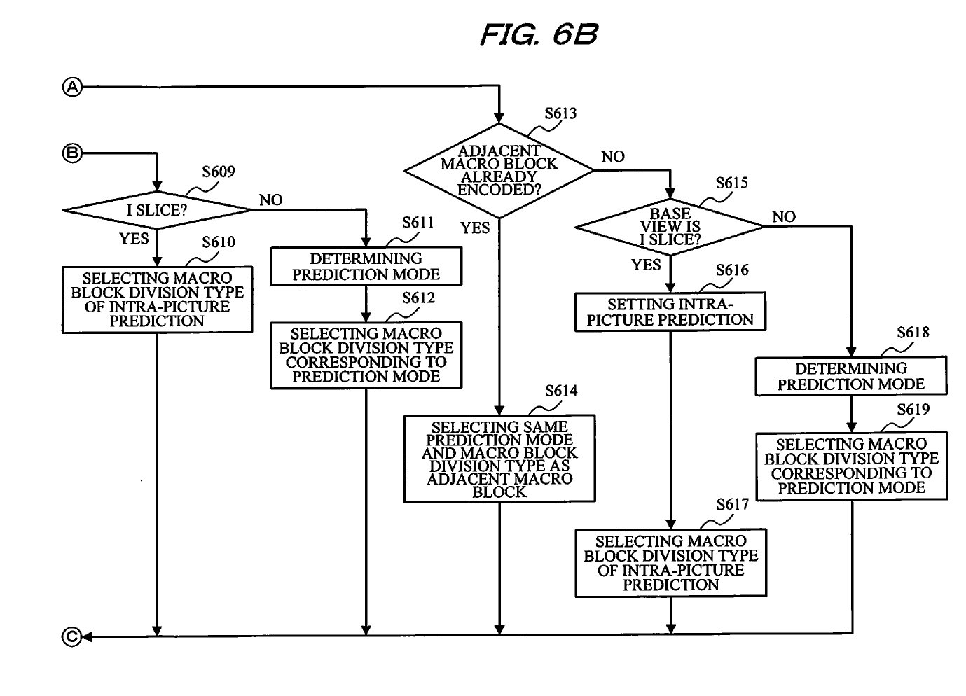

Next, encoding processing by the image processing apparatus 101 will be described below with the use of flow charts illustrated in FIG. 5 and FIGS. 6A and 6B. The processing of the flow charts illustrated in FIG. 5 and FIGS. 6A and 6B is performed by the control unit 105 which controls each unit.

The image processing apparatus 101 has a transposing mode and a normal mode as encoding processing. The transposing mode is a mode which controls encoding so that an encoding parameter used when the image processing apparatus 101 encodes the multi-viewpoint moving image data can be used, when the image processing apparatus 111 decodes the encoded multi-viewpoint moving image data, converts the decoded multi-viewpoint moving image data into a side-by-side image, and then encodes the converted image in accordance with MPEG4 MVC. The normal mode is a mode which controls the encoding of the multi-viewpoint moving image data without such a restriction that the encoding parameter also can be used for the encoding of the side-by-side image, as will be described later. A user can set the modes while switching between the transposing mode and the normal mode, by operating the operation unit 104.

Firstly, when there is such an instruction from the operation unit 104 as to start encoding, the control unit 105 discriminates whether the transposing mode is set or not (S501). When the transposing mode is set, the image processing apparatus 101 performs the encoding processing in the transposing mode (S502). When the normal mode is set, the image processing apparatus 101 performs the encoding processing in the normal mode (S503).

Next, the basic operation of the encoding of multi-viewpoint moving image data will be described below.

The input unit 102 inputs the multi-viewpoint moving image data in order illustrated in FIG. 2 (in order of display), and the memory 103 stores the input data therein. The encoding method determining unit 106 reads out the left eye image and the right eye image in the multi-viewpoint moving image data, which are stored in the memory 103, respectively in order of the encoding processing. The encoding method determining unit 106 appropriately reads out the data of a partially decoded reference picture from the memory 103, performs a simple intra-picture prediction, and an inter-picture prediction processing including a motion compensation prediction or a parallax compensation prediction, to the read out data, and thereby calculates the evaluation value showing encoding efficiency for each macro block. The macro block is a unit of the encoding of the moving image data, but the detail will be described later.

The encoding method determining unit 106 determines such a prediction encoding method of the multi-viewpoint moving image data, which provides the optimum encoding efficiency, on the basis of the calculated evaluation value. When the subject macro block of encoding is an I slice, the encoding method determining unit 106 determines the block size of the intra-picture prediction and the prediction mode. In addition, when the subject macro block of encoding is a P slice or a B slice of a base view, the encoding method determining unit 106 selects a prediction mode having higher encoding efficiency, from the intra-picture prediction and the motion compensation (inter-picture) prediction. When having selected the intra-picture prediction, the encoding method determining unit 106 determines an intra-picture prediction encoding parameter such as the block size of the intra-picture prediction and the intra-picture prediction mode. In addition, when having selected the motion compensation prediction, the encoding method determining unit 106 determines a parameter for encoding the motion compensation prediction, such as a reference picture, macro block division information and a motion vector.

In addition, when the subject macro block of encoding is the P slice or the B slice of a non-base view, the encoding method determining unit 106 selects a prediction mode having higher encoding efficiency, from the intra-picture prediction, the motion compensation prediction, and in addition, the parallax compensation prediction. When having selected the parallax compensation prediction, the encoding method determining unit 106 determines a parameter for encoding the motion compensation prediction, such as the reference picture, the macro block division information and a parallax vector.

The encoding method determining unit 106 outputs the parameter for prediction encoding of the multi-viewpoint moving image data of the subject macro block of encoding, which is determined in this way, to a prediction encoding unit 107.

Next, the macro block will be described below. In MPEG4 MVC and MPEG4 AVC, the encoding processing is performed while using the macro block which includes a predetermined number of pixels, as a unit. The macro block includes 16 pixels in a horizontal direction and 16 pixels in a vertical direction. In MPEG4 MVC and MPEG4 AVC, a plurality of macro block division types is also prepared (defined). The macro block division type means a division type of smaller blocks into which one macro block is divided.

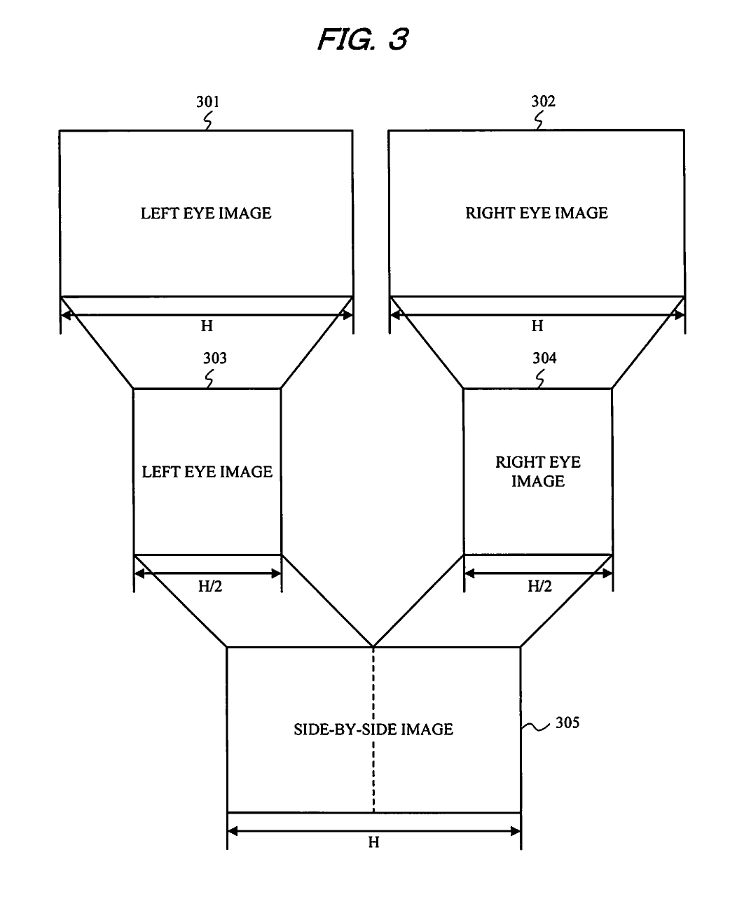

Incidentally, in the present embodiment, as is illustrated in FIG. 3, the image processing apparatus reduces the number of pixels in a horizontal direction of each of the decoded the left eye image 301 and the right eye image 302 to a half, combines the resultant images, and generates a side-by-side image 305 of one picture. When the side-by-side image which is generated by such a combining method is encoded according to MPEG4 AVC, the number of horizontal pixels in each macro block in the left eye image 301 and the right eye image 302 is also decreased to be a half. The adjacent two macro blocks in the left eye image 301 and the right eye image 302 become one macro block in the side-by-side image.

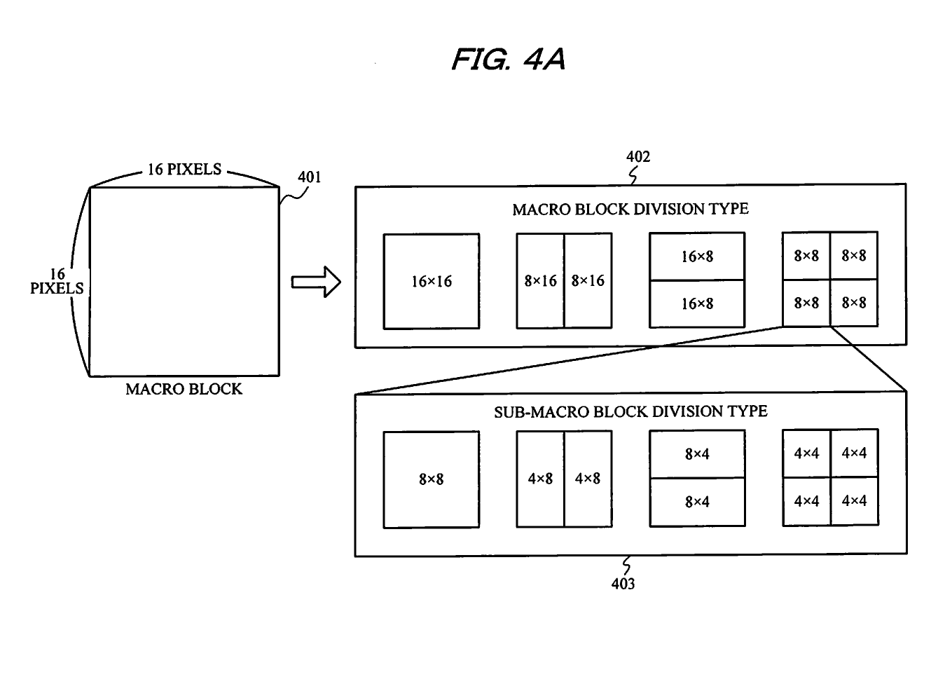

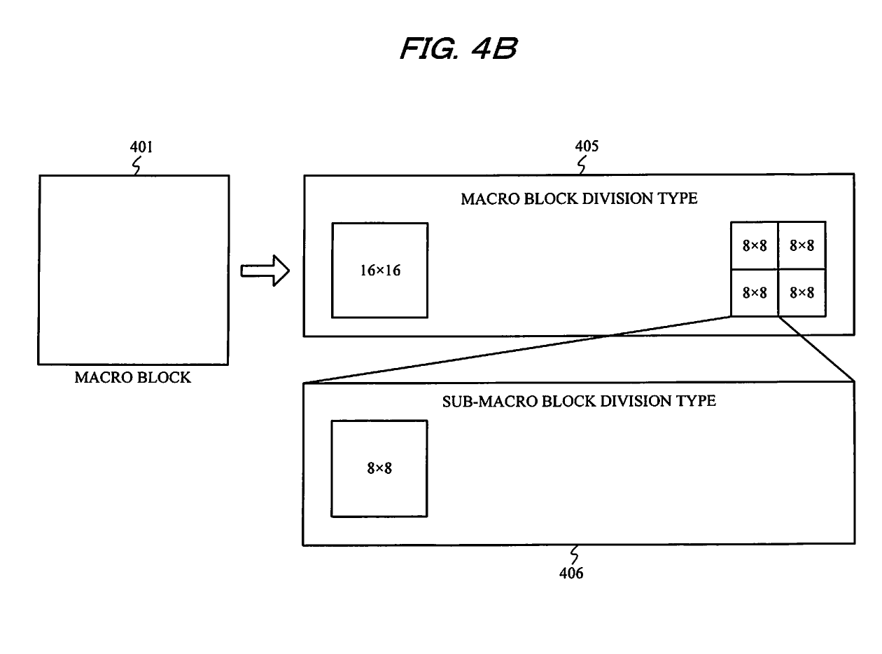

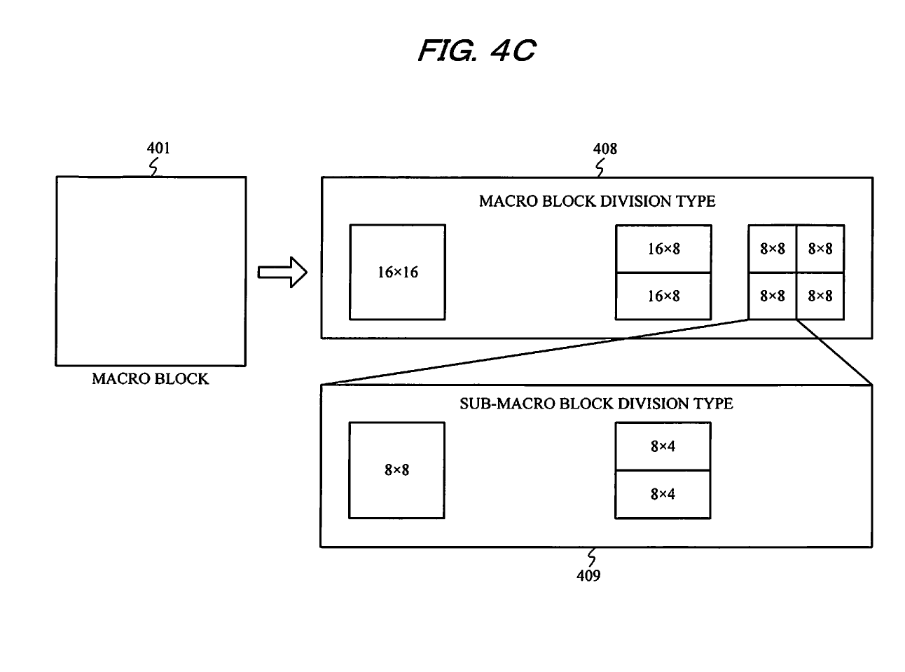

FIGS. 4A to 4C are views conceptually illustrating a configuration of the macro block. In the figures, the size of the block which illustrates a sub-macro block division type is illustrated so as to be larger than that of the macro block division type, for convenience, in order that the blocks are easily viewed. Incidentally, MPEG4 MVC is similar to MPEG4 AVC, in regard to the macro block division type which is a unit of the prediction encoding.

As is illustrated in FIG. 4A, one macro block 401 includes 16 pixels in a horizontal direction and 16 pixels in a vertical direction. In addition, four types of 16×16 pixels, 8×16 pixels, 16×8 pixels, and 8×8 pixels are defined as the macro block division type 402. When the macro block division type is 8×8 pixels, the 8×8 pixel unit is referred to as a sub-macro block. Four types of 8×8 pixels, 4×8 pixels, 8×4 pixels, and 4×4 pixels are defined as the sub-macro block division type 403. In each of the macro block division types, an intra-picture prediction mode is set for each divided block, and the motion vector or the parallax vector is calculated for each divided block. In addition, in each of the sub-macro block division types, the intra-picture prediction mode is set for each divided block, and the motion vector or the parallax vector is calculated for each divided block.

From these macro block division types, in the intra-picture prediction, the two types of macro block division types can be used, which are 16×16 pixels and 8×8 pixels. In addition, two types of 8×8 pixels and 4×4 pixels can be used as the sub-macro block division type. However, as for the sub-macro block division type in one macro block, only one type can be selected. As for the inter-picture prediction including the motion compensation and the parallax compensation, all of the macro block division types can be used, and when the macro block division type of the 8×8 pixels is selected, all of the sub-macro block division types can be used for the sub-macro block.

In the present example, in the transposing mode, the image processing apparatus selects the same macro block division type for each two macro blocks (referred to as macro block pair), which are adjacent to each other in a horizontal direction. In the case of the intra-picture prediction encoding, as is illustrated in FIG. 4B, any one of 16×16 pixels and 8×8 pixels can be used as the macro block division type, and 8×8 pixels can be used as the sub-macro block division type. Here, as for the sub-macro block division type of 4×4 pixels, when the number of the horizontal pixels is decreased to a half, the resultant block becomes 2×4 pixels, and the two adjacent blocks of 2×4 pixels constitute one block of 4×4 pixels after the conversion into the side-by-side image. It is prohibited to use the 4×4 pixels as the sub-macro block division type, because the motion vectors or the parallax vectors of the two adjacent blocks of 2×4 pixels are occasionally different from each other.

In addition, in the case of the inter-picture prediction encoding, as is illustrated in FIG. 4C, any one of 16×16 pixels, 16×8 pixels and 8×8 pixels can be used as the macro block division type, and any one of 8×8 pixels and 8×4 pixels can be used as the sub-macro block division type. Here, when the number of the horizontal pixels of the macro block division type of 8×16 pixels is decreased to a half, the resultant block becomes 4×16 pixels. The two adjacent blocks of 4×16 pixels constitute one block of 8×16 pixels, after the conversion into the side-by-side image. It is prohibited to use the 8×16 pixels as the macro block division type, because the motion vectors or the parallax vectors of the two adjacent blocks of 8×16 pixels are occasionally different from each other. In addition, when the number of the horizontal pixels of the sub-macro block division type of 4×8 pixels is decreased to a half, the resultant block becomes 2×8 pixels. The two adjacent blocks of 2×8 pixels constitute one block of 4×8 pixels, after the conversion into the side-by-side image. It is prohibited to use the 4×8 pixels as the sub-macro block division type, because the motion vectors or the parallax vectors of the two adjacent blocks of 2×8 pixels are occasionally different from each other. In addition, when the number of the horizontal pixels of the sub-macro block division type of 4×4 pixels is decreased to a half, the resultant block becomes 2×4 pixels. The two adjacent blocks of 2×4 pixels constitute one block of 4×4 pixels, after the conversion into the side-by-side image. It is prohibited to use the 4×4 pixels as the sub-macro block division type, because the motion vectors or the parallax vectors of the two adjacent blocks of 2×4 pixels are occasionally different from each other.

Thus, the same macro block division type is selected for the macro block pair. Thereby, when the multi-viewpoint moving image is converted into the side-by-side image and then the converted image is encoded according to the MPEG4 AVC method, the encoding parameter generated according to the MPEG4 MVC method is enabled to be used.

When the picture of the base view is the I slice, in other words, when the picture is encoded only by the intra-picture prediction encoding, the intra-picture prediction is selected also for the picture of the corresponding (of same time) non-base view. Thus, by encoding both of the images which are the base view and the non-base view of the same time by the intra-picture prediction, the converted image can be encoded as the I slice when the images are converted into the side-by-side image and then the converted image is encoded according to the MPEG4 AVC method.

FIG. 6 is comprised of FIGS. 6A and 6B, showing a view illustrating a flow chart of processing in a transposing mode. In the transposing mode, the encoding method determining unit 106 sets any of 16×16 pixels and 8×8 pixels as the macro block division type of the intra-picture prediction, and 8×8 pixels as the sub-macro block division type thereof, as in the above description (S601). In addition, the encoding method determining unit 106 sets any of 16×16 pixels, 16×8 pixels and 8×8 pixels as the macro block division type of the inter-picture prediction, and any of 8×8 pixels and 8×4 pixels as the sub-macro block division type thereof (S602).

Next, the encoding method determining unit 106 discriminates whether the subject macro block of encoding is moving image data of the base view or not (S603). When the subject macro block of encoding is the base view, the encoding method determining unit 106 discriminates whether the adjacent macro block including the subject macro block of encoding in the macro block pair is already encoded or not (S604). When the adjacent macro block is already encoded, the encoding method determining unit 106 selects the same prediction mode and the same macro block division type as those of the adjacent macro block (S605).

In addition, when the adjacent macro block in the same macro block pair has not been yet encoded in S604, the encoding method determining unit 106 discriminates whether the subject macro block of encoding is the I slice or not (S609). When the subject macro block of encoding is the I slice, the encoding method determining unit 106 selects the macro block division type of the intra-picture prediction illustrated in FIG. 4B, and selects a prediction mode having higher efficiency, from a plurality of the intra-picture prediction modes (S610). When the subject macro block of encoding is not the I slice, the encoding method determining unit 106 selects a prediction mode having higher encoding efficiency, from the intra-picture prediction and the inter-picture prediction (S611). Then, the encoding method determining unit 106 selects a macro block division type corresponding to the selected prediction mode, from the macro block division types of the intra-picture prediction and the inter-picture prediction (S612).

On the other hand, when the subject macro block of encoding is the non-base view in S603, the encoding method determining unit 106 discriminates whether the adjacent macro block including the subject macro block of encoding in the macro block pair is already encoded or not (S613). When the adjacent macro block is already encoded, the encoding method determining unit 106 selects the same prediction mode and the same macro block division type as those of the adjacent macro block (S614).

In addition, when the adjacent macro block in the same macro block pair is not yet encoded in S613, the encoding method determining unit 106 discriminates whether the image of the base view corresponding to the subject macro block of encoding is the I slice or not (S615). When the image of the base view corresponding to the subject macro block of encoding is the I slice, the encoding method determining unit 106 sets the prediction mode of the subject macro block of encoding to the intra-picture prediction (S616). Then, the encoding method determining unit 106 selects the macro block division type of the intra-picture prediction illustrated in FIG. 4B (S617). In addition, when the image of the base view corresponding to the subject macro block of encoding is not the I slice, the encoding method determining unit 106 selects a prediction mode having higher encoding efficiency, from the intra-picture prediction and the inter-picture prediction (S618). Then, the encoding method determining unit 106 selects a macro block division type corresponding to the selected prediction mode, from the macro block division types of the intra-picture prediction and the inter-picture prediction (S619).

Next, the encoding method determining unit 106 determines an encoding parameter such as the motion vector and the parallax vector, on the basis of the selected prediction mode and the macro block division type (S606). Incidentally, when the macro block division type of the inter-picture prediction illustrated in FIG. 4C is selected in S605, S612, S614 and S619, the encoding method determining unit 106 selects the inter-picture prediction mode of the motion compensation or the parallax compensation, as the prediction mode. Then, the encoding method determining unit 106 sends information of the encoding parameter such as the selected macro block division type, reference picture, prediction mode and motion vector, to a prediction encoding unit 107, and simultaneously stores the information in the memory 103.

The prediction encoding unit 107 encodes the subject macro block of encoding, on the basis of the encoding parameter sent from the encoding method determining unit 106 (S607). In other words, when performing the intra-picture prediction, the prediction encoding unit 107 generates prediction error data between the data and the subject macro block of encoding on the same picture, in accordance with the determined prediction mode. In addition, when performing the inter-picture prediction, the prediction encoding unit 107 reads out the data of the reference picture from the memory 103, in accordance with the determined prediction mode, and generates prediction error data between the subject data of encoding and the reference data. Then, the prediction encoding unit 107 performs orthogonal transform processing on a designated pixel block unit (block unit of 8×8 pixels or 4×4 pixels). The prediction encoding unit 107 quantizes a conversion coefficient which is obtained by the orthogonal transform processing through a quantization step corresponding to the designated quantization parameter, and outputs the quantized data to an entropy encoding unit 108.

The prediction encoding unit 107 also performs inverse quantization processing and inverse orthogonal transform processing with respect to the quantized data, and adds the prediction data to the processed data to generate partially decoded data. Then, this partially decoded data is stored in the memory 103. The data which is stored in the memory 103 is used in the subsequent intra-picture prediction processing. Furthermore, the prediction encoding unit 107 performs deblocking filtering processing with respect to the partially decoded data, and then stores the processed data in the memory 103. The data which is stored in the memory 103 after the deblocking filtering processing is used in the subsequent inter-picture prediction processing.

The entropy encoding unit 108 performs entropy encoding processing with respect to the input quantized data, and outputs the processed data to the memory 103. Here, the entropy encoding processing includes the following two encodings. Specifically, the encodings include context adaptive variable length encoding (Context-based Adaptive Variable Length Coding, which is hereinafter referred to as CAVLC), and context adaptive binary arithmetic encoding (Context-based Adaptive Binary Arithmetic Coding, which is hereinafter referred to as CABAC).

The control unit 105 discriminates whether there is such an instruction from the operation unit 104 as to end the encoding processing or not (S608), and when there is such an instruction as to end the encoding processing, the control unit 105 ends the processing. When there has not been such an instruction as to end the encoding, the process returns to S603, and then processing for the next macro block is continued.

Moving image data which is encoded in this way is stored in the memory 103 once. Then, the output unit 109 multiplexes the encoded left eye image data and right eye image data, and information on the encoding parameter, and outputs the resultant data to the outside as multi-viewpoint encoded data. The output unit 109 also outputs distinguishing information for distinguishing between the transposing mode and the normal mode to the outside, in addition to the multi-viewpoint encoded data.

Next, the encoding processing of the normal mode will be described below. In the normal mode, all of the macro block division types which can be used for the intra-picture prediction or the inter-picture prediction are used as the macro block division type. In addition, in the normal mode, the macro block division type is determined independently for each macro block, regardless of the macro block division type of the same macro block pair. In addition, in the normal mode, as for the image of the non-base view, the prediction mode is determined regardless of the slice type of the image of the corresponding base view.

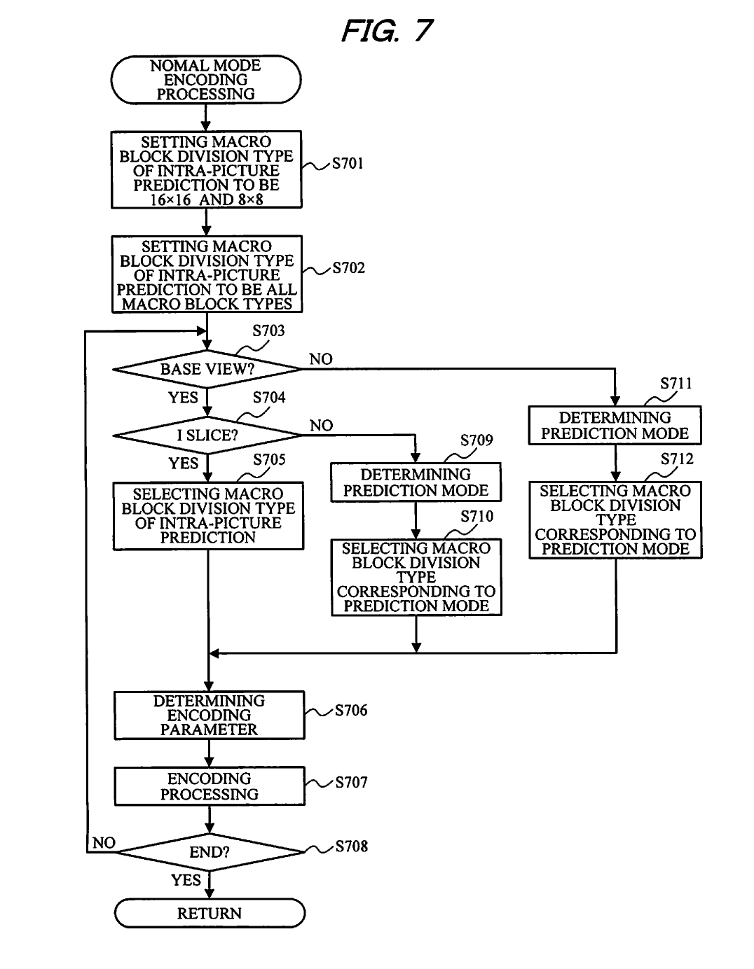

FIG. 7 is a flow chart illustrating the processing of the normal mode. In the normal mode, the encoding method determining unit 106 sets 16×16 pixels and 8×8 pixels as the macro block division type of the intra-picture prediction, and 8×8 pixels and 4×4 pixels as the sub-macro block division type thereof, as in the above description (S701). In addition, the encoding method determining unit 106 sets all of the macro block division types as the macro block division type of the inter-picture prediction, and all of the sub-macro block division types as the sub-macro block division type thereof (S702).

Next, the encoding method determining unit 106 discriminates whether the subject macro block of encoding is moving image data of the base view or not (S703). When the subject macro block of encoding is the base view, the encoding method determining unit 106 discriminates whether the subject macro block of encoding is the I slice or not (S704). When the subject macro block of encoding is the I slice, the encoding method determining unit 106 selects a macro block division type having higher encoding efficiency, from the macro block division types of the intra-picture prediction (S705). When the subject macro block of encoding is not the I slice, the encoding method determining unit 106 selects a prediction mode having higher encoding efficiency, from the intra-picture prediction and the inter-picture prediction (S709). Then, the encoding method determining unit 106 selects a macro block division type corresponding to the selected prediction mode, from the macro block division types of the intra-picture prediction and the inter-picture prediction (S710).

On the other hand, when the subject macro block of encoding is the non-base view in S703, the encoding method determining unit 106 selects a prediction mode having higher encoding efficiency, from the intra-picture prediction and the inter-picture prediction (S711). Then, the encoding method determining unit 106 selects a macro block division type corresponding to the selected prediction mode, from the macro block division types of the intra-picture prediction and the inter-picture prediction (S712).

Next, the encoding method determining unit 106 determines an encoding parameter such as the prediction mode, the motion vector and the parallax vector, on the basis of the slice type and the macro block division type of the subject macro block of encoding (S706). Then, the encoding method determining unit 106 sends information of the encoding parameter such as the selected macro block division type, reference picture, prediction mode and motion vector, to the prediction encoding unit 107, and simultaneously stores the information in the memory 103.

The prediction encoding unit 107 encodes the subject macro block of encoding on the basis of the encoding parameter sent from the encoding method determining unit 106, in a similar way to that in the transposing mode. Furthermore, the entropy encoding unit 108 performs the entropy encoding unit, and the memory 103 stores the encoded data therein, in a similar way to that in the transposing mode (S707). When there is such an instruction as to end the encoding, the entropy encoding unit 108 ends the encoding processing (S708). The output unit 109 multiplexes the encoded left eye image data and right eye image data, and information on the encoding parameter, and outputs the resultant data to the outside as multi-viewpoint image encoded data. The output unit 109 also outputs distinguishing information for distinguishing between the transposing mode and the normal mode to the outside, in addition to the multi-viewpoint image encoded data.

The configuration of the image processing apparatus 101 of the present invention is described in the above. The image processing apparatus 101 has the transposing mode of generating the encoding parameter for encoding the multi-viewpoint moving image data, considering that the macro block of the side-by-side moving image data is converted from the macro block pair of the multi-viewpoint moving image data. Thereby, the image processing apparatus 101 can easily convert the encoding parameter of the macro block pair of the multi-viewpoint moving image data so as to correspond to an encoding parameter of the macro block of the side-by-side image.

Next, an image processing apparatus 111 will be described below. The image processing apparatus 111 decodes the input multi-viewpoint image encoded data, and outputs the left eye moving image data and the right eye moving image data to an external apparatus. The image processing apparatus 111 also performs conversion processing of decoding the input multi-viewpoint image encoded data, then converting the decoded multi-viewpoint image into the side-by-side image, and encoding the converted image in accordance with MPEG4 AVC. In addition, when the input multi-viewpoint image encoded data is encoded in the transposing mode, the image processing apparatus 111 generates an encoding parameter at the time when the side-by-side image is encoded, by using the encoding parameter of the multi-viewpoint image encoded data, in the conversion processing.

In the image processing apparatus 111, an input unit 112 inputs the multi-viewpoint image encoded data which is output from the image processing apparatus 101. A memory 113 stores the input multi-viewpoint image encoded data, information on the encoding parameter of each macro block, which is added to the multi-viewpoint image encoded data, and other information therein. An operation unit 114 has a power source switch, a switch for directing to input the multi-viewpoint image encoded data and to start and stop decoding processing, a switch for directing to convert the multi-viewpoint image into the side-by-side image, and the like. A control unit 115 has a CPU (microcomputer), a memory and the like, and controls the operation of the image processing apparatus 111 in response to the direction sent from the operation unit 114. A decoding unit 116 decodes the input multi-viewpoint image encoded data, and outputs the left eye moving image data and right eye moving image data. An output unit 117 outputs multi-viewpoint moving image data including the decoded left eye moving image data and right eye moving image data, to an external apparatus such as a display apparatus having an ability of three-dimensional display. In addition, when there is such an instruction as to convert the moving image data into the side-by-side image, the output unit 117 outputs the encoded side-by-side image data.

An image processing unit 118 generates the side-by-side image by using the decoded left eye image and right eye image. In addition, a parameter conversion unit 119 generates an encoding parameter which is used for encoding the side-by-side image, by using the encoding parameter that is added to the multi-viewpoint image encoded data. An encoding method determining unit 120 determines a parameter such as a slice type and a macro block division type at the time when the side-by-side image is encoded and a prediction encoding mode. When the input multi-viewpoint image encoded data is encoded in the transposing mode, the encoding method determining unit 120 determines the parameter such as the slice type, the macro block division type and the prediction encoding mode, on the basis of the encoding parameter sent from the parameter conversion unit 119. A prediction encoding unit 121 generates prediction error data of the side-by-side image data according to an encoding parameter which is determined by the encoding method determining unit 120, and generates data which is obtained by orthogonally transforming the generated prediction error data. An entropy encoding unit 122 performs entropy encoding processing to the data sent from the prediction encoding unit 121. An output unit 109 outputs the encoded multi-viewpoint moving image data to an external apparatus including the image processing apparatus 111, through a transmission path such as a wired transmission path and a wireless transmission path.

In addition, the encoding method determining unit 120, the prediction encoding unit 121 and the entropy encoding unit 122 have similar functions to those of the encoding method determining unit 106, the prediction encoding unit 107 and the entropy encoding unit 108. The control unit 115 controls these units, and specifically achieves the encoding by making a CPU, for instance, execute a control program.

In the image processing apparatus 111, when there is such an instruction from the operation unit 114 as to start the decoding, the control unit 115 makes the input unit 112 input the multi-viewpoint image encoded data. The input unit 112 inputs the multi-viewpoint image encoded data from the image processing apparatus, and sequentially stores the input data in the memory 113 through a bus 123. Next, the control unit 115 directs the decoding unit 116 to start the decoding processing. The decoding unit 116 sequentially reads out the multi-viewpoint image encoded data from the memory 113, and decodes the read out data. The memory 113 stores the decoded left eye moving image data and right eye moving image data therein once. The control unit 115 directs the output unit 117 to output the decoded moving image data. The output unit 117 reads out the decoded left eye moving image data and right eye moving image data from the memory 113, and outputs the read out data to the outside.

Next, conversion processing will be described below. As is described above, in such a state that the multi-viewpoint image encoded data is being input or in another state, when there is such an instruction from the operation unit 114 as to convert the moving image data into the side-by-side image, the control unit 115 controls each unit to start the conversion processing.

The control unit 115 discriminates whether the input multi-viewpoint image encoded data is encoded by the transposing mode or not. When the input multi-viewpoint image encoded data is encoded by the transposing mode, the control unit 115 controls each unit so as to encode the side-by-side image by using the encoding parameter of the multi-viewpoint image encoded data.

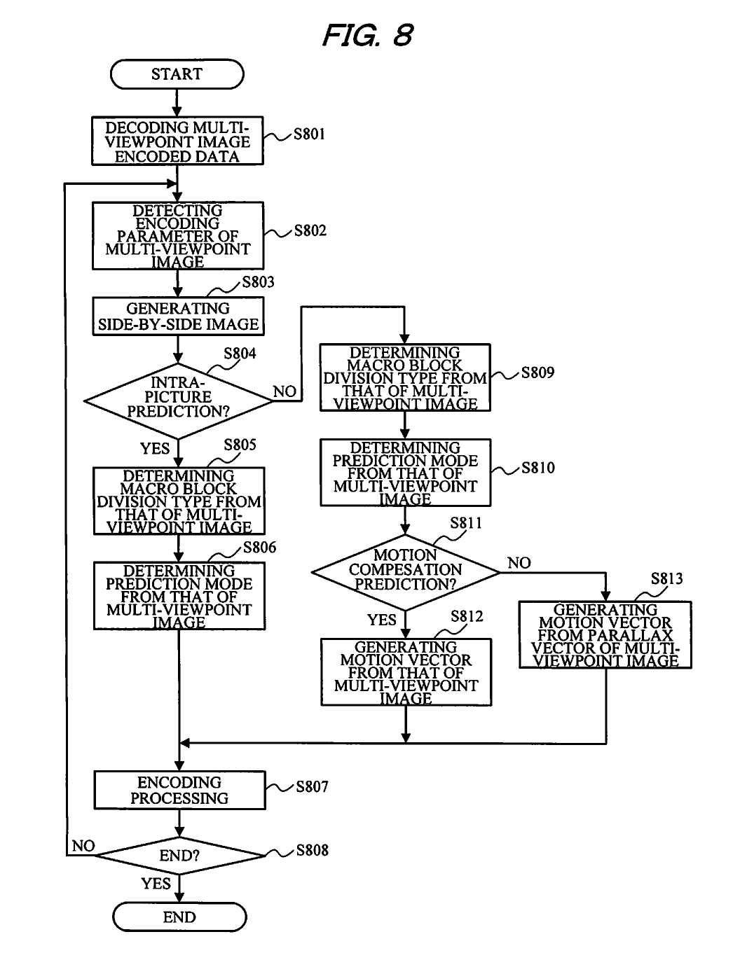

FIG. 8 illustrates a flow chart of conversion processing of multi-viewpoint image encoded data which is encoded by the transposing mode. The processing illustrated in FIG. 8 is performed by the control unit 115 which controls each unit.

When there is such an instruction from the operation unit 114 as to start conversion processing, the control unit 115 makes the input unit 112 input the multi-viewpoint image encoded data. The input unit 112 inputs the multi-viewpoint image encoded data from the image processing apparatus 101, and sequentially stores the input data in the memory 113 through a bus 123. Next, the control unit 115 directs the decoding unit 116 to start the decoding processing. The decoding unit 116 sequentially reads out the multi-viewpoint image encoded data from the memory 113, decodes the read out data, and stores the decoded left eye moving image data and right eye moving image data in the memory 113 once (S801). The decoding unit 116 outputs also information on the encoding parameter of each macro block, and stores the information in the memory 113 (S802).

Next, the control unit 115 directs the image processing unit 118 to generate the side-by-side image. The image processing unit 118 reads out the left eye image and the right eye image which are photographed in the same time period, from the left eye moving image data and right eye moving image data that are stored in the memory 113. Then, as is illustrated in FIG. 3, the image processing unit reduces the number of pixels in a horizontal direction of each of the read out image data to a half, combines the image for the left eye and the image for the right eye of which the pixel numbers are each decreased, and generates the side-by-side image (S803). In this way, the image processing unit 118 sequentially generates the side-by-side image, and stores the generated image in the memory 113.

Next, the control unit 115 instructs the parameter conversion unit 119 to generate the encoding parameter, and simultaneously instructs the encoding method determining unit 120, the prediction encoding unit 121 and the entropy encoding unit 122 to start encoding processing.

The parameter conversion unit 119 performs the conversion processing of the encoding parameter, by using the macro block pair in the left eye image and the right eye image which are not yet converted into the side-by-side image, as a unit. In the present embodiment, the two macro blocks of the macro block pair in the multi-viewpoint moving image data are subjected to the encoding processing as one macro block in the side-by-side image. Accordingly, the parameter conversion unit 119 converts the encoding parameter in the multi-viewpoint moving image data so that the encoding parameter of the macro block pair in the multi-viewpoint moving image data corresponds to the encoding parameter of one macro block at the time when the side-by-side image is encoded.

The parameter conversion unit 119 discriminates whether the prediction mode of the macro block pair in the multi-viewpoint moving image data, which corresponds to the subject macro block of encoding, is an intra-picture prediction or not, on the basis of the information on the encoding parameter stored in the memory 113 (S804). When the prediction mode is the intra-picture prediction, the parameter conversion unit 119 determines the macro block division type of the subject macro block of encoding, from the macro block division type of the macro block pair in the multi-viewpoint moving image data (S805).

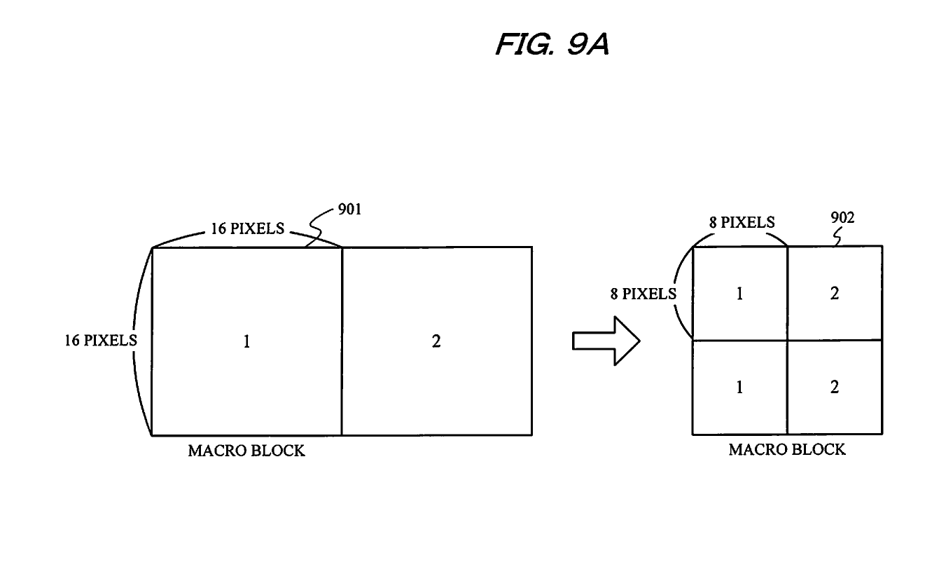

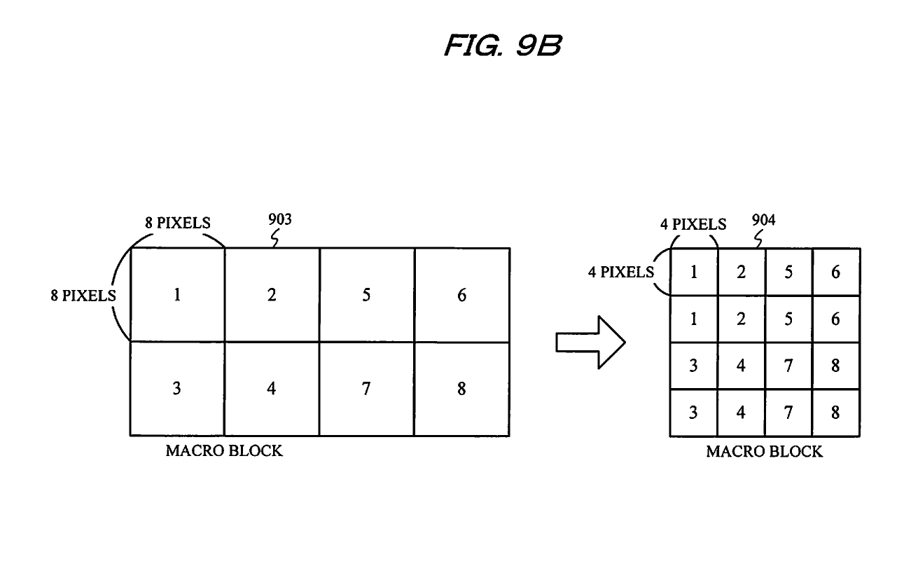

Here, as is illustrated in FIGS. 9A and 9B, the parameter conversion unit 119 converts any of the two types of the macro block division types of 16×16 pixels and 8×8 pixels into the macro block division type of which the number of pixels in a horizontal direction is decreased to a half. FIG. 9A illustrates the case in which the macro block division type 901 of the multi-viewpoint image is 16×16 pixels. In this case, the macro block division type 901 is converted into the macro block division type 902 of 8×8 pixels. FIG. 9B illustrates the case in which the macro block division type 903 is 8×8 pixels, and the sub-macro block division type 904 is 8×8 pixels. In this case, the above macro block division type and the above sub-macro block division type are converted into the macro block division type of 8×8 pixels and the sub-macro block division type of 4×4 pixels, respectively.

Next, the parameter conversion unit 119 determines the intra-picture prediction mode of the subject macro block of encoding, from the intra-picture prediction mode of the multi-viewpoint moving image data (S806). The figures of each block illustrated in FIGS. 9A and 9B show correspondence between intra-picture prediction modes before and after the conversion. For instance, suppose that portions of the number 1 and the number 2 in the macro block of the multi-viewpoint moving image data illustrated in FIG. 9B are vertical, a portion of the number 3 is DC (average), and a portion of the number 4 is horizontal of the intra-picture prediction. In this case, the portions of the number 1 and the number 2 in the subject macro block of encoding shall be vertical in the intra-picture prediction mode, the portion of the number 3 shall be DC (average) therein, and the portion of the number 4 shall be horizontal therein. The encoding parameter for the intra-picture prediction is converted in the above-described way.

On the other hand, when the prediction mode of the macro block pair in the multi-viewpoint moving image data, which corresponds to the subject macro block of encoding, is not the intra-picture prediction, the processing will be performed in the following way. Specifically, the parameter conversion unit 119 determines the macro block division type of the subject macro block of encoding, from the macro block division type in the multi-viewpoint moving image data (S809).

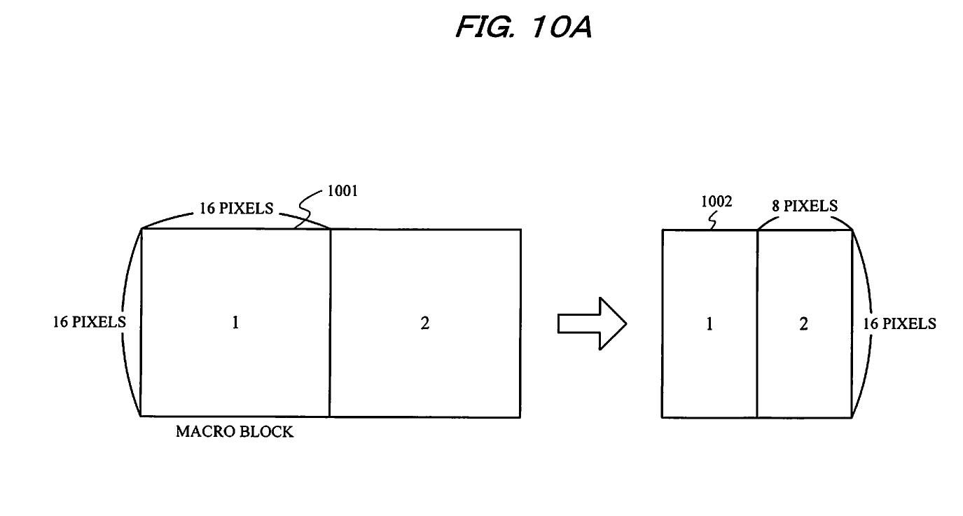

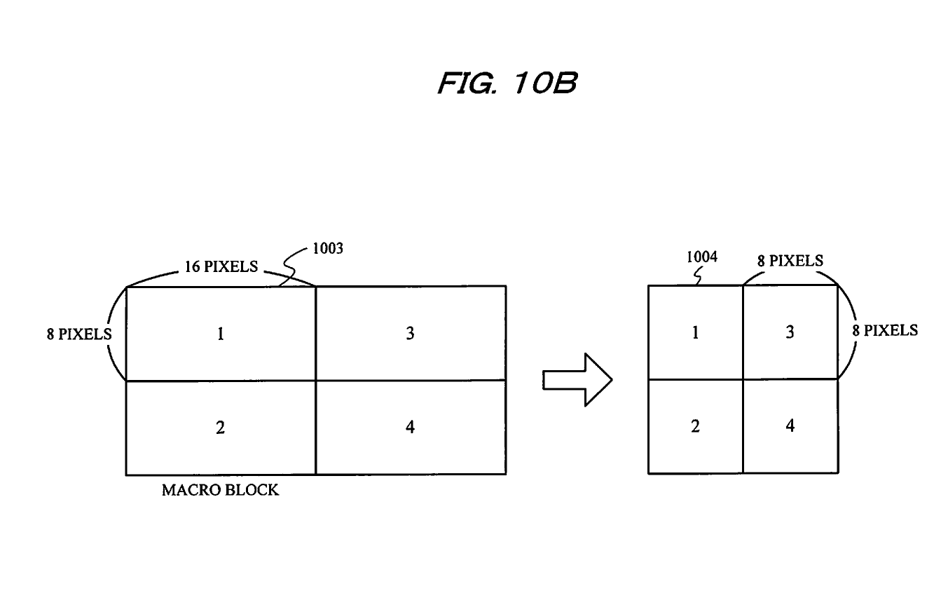

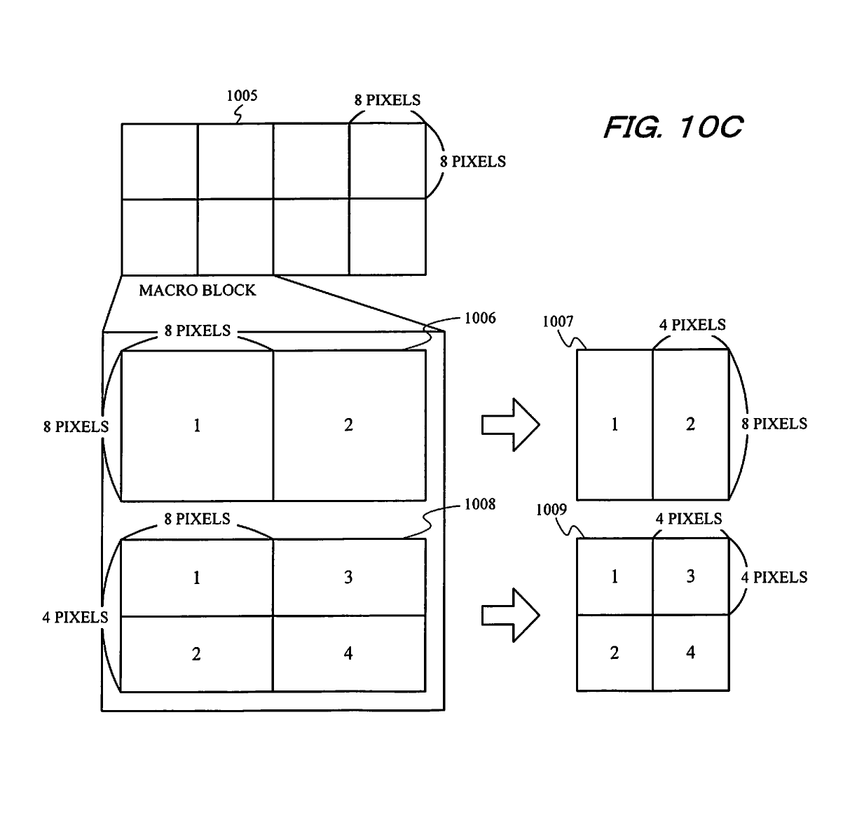

Here, as is illustrated in FIGS. 10A to 10C, the parameter conversion unit 119 converts any of three types of the macro block division types of 16×16 pixels, 16×8 pixels and 8×8 pixels into the macro block division type of which the number of pixels in a horizontal direction is decreased to a half. FIG. 10A illustrates the case in which a macro block division type 1001 of multi-viewpoint moving image data is 16×16 pixels. In this case, the macro block division type 1001 is converted into a macro block division type 1002 of 8×16 pixels. FIG. 10B illustrates the case in which a macro block division type 1003 of multi-viewpoint moving image data is 16×8 pixels. In this case, the macro block division type 1003 is converted into a macro block division type 1004 of 8×8 pixels. FIG. 10C illustrates the case in which a macro block division type 1005 of multi-viewpoint moving image data is 8×8 pixels. In this case, each sub-macro block is further converted. When a sub-macro block division type 1006 is 8×8 pixels, the sub-macro block division type 1006 is converted into a macro block division type 1007 of 4×8 pixels. When a sub-macro block division type 1008 is 8×4 pixels, the sub-macro block division type 1008 is converted into a sub-macro block division type 1009 of 4×4 pixels.

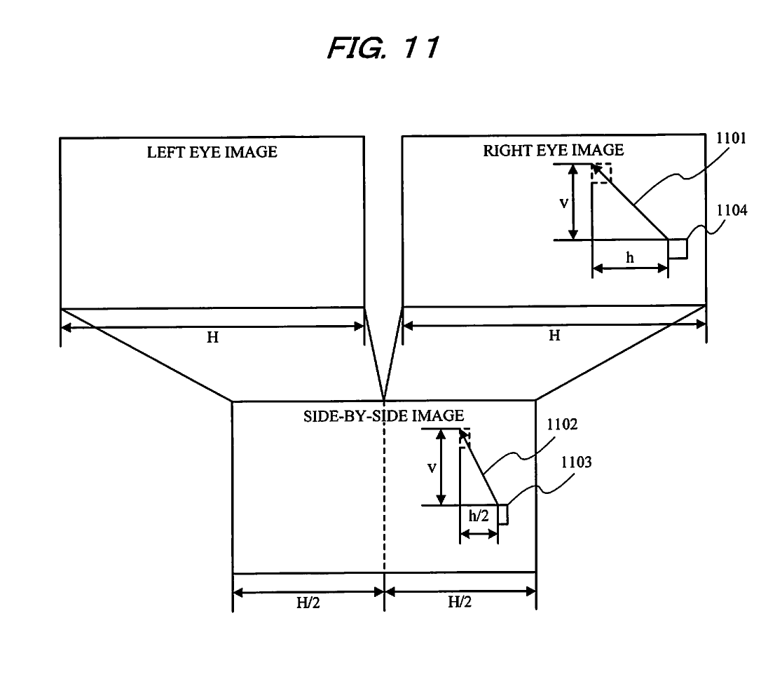

Next, the parameter conversion unit 119 determines the prediction mode of the subject macro block of encoding, from the prediction mode of a macro block pair in multi-viewpoint moving image data (S810). Next, the parameter conversion unit 119 discriminates whether the prediction mode of the subject macro block of encoding is the motion compensation prediction or not (S811). When the subject macro block of encoding is the motion compensation prediction, the parameter conversion unit 119 generates a motion vector of the subject macro block of encoding by using the motion vector of the macro block of the multi-viewpoint moving image data, which corresponds to the subject macro block of encoding (S812). The figures of each block illustrated in FIGS. 10A and 10C show correspondence between subject blocks of which the motion vectors are to be generated before and after the conversion. For instance, the motion vector of the first macro block in the macro block 1004 of the side-by-side image is generated by the conversion of the motion vector of the first block in the macro block pair 1003 of the multi-viewpoint moving image data. An encoding direction determining unit 119 generates a motion vector 1102 by decreasing the length in a horizontal direction of a motion vector 1101 of a macro block 1104 of the multi-viewpoint moving image data to a half, which corresponds to the subject macro block of encoding 1103, as is illustrated in FIG. 11.

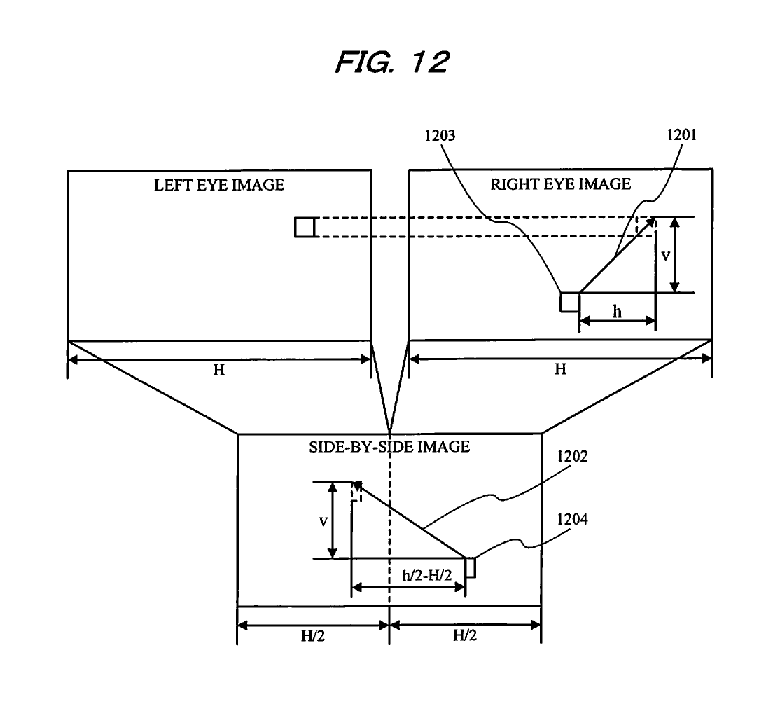

In addition, when the prediction mode of the subject macro block of encoding is not the motion compensation prediction, the subject macro block of encoding is a parallax compensation prediction. The parameter conversion unit 119 generates the motion vector of the subject macro block of encoding, by using the parallax vector of the macro block of the multi-viewpoint moving image data, which corresponds to the subject macro block of encoding (S813). The parameter conversion unit 119 decreases the length in a horizontal direction of a motion vector 1201 of a macro block 1204 of the multi-viewpoint moving image data, which corresponds to a subject macro block 1203 of encoding, to a half, as is illustrated in FIG. 12. Then, an encoding direction determining unit 120 calculates a motion vector 1202 by subtracting an offset value which corresponds to reducing the number of the pixels to a half in a horizontal direction of one picture in the multi-viewpoint moving image data, from the length in a horizontal direction of the motion vector.

In addition, when the subject macro block of encoding is the parallax compensation prediction and further is the B slice, the parameter conversion unit 119 sets a picture which is one picture forward of a picture including the subject macro block of encoding, as a reference picture. In addition, when the subject macro block of encoding is the parallax compensation prediction and further is the P slice, the parameter conversion unit 119 sets a picture of the P slice immediately forward of a picture including the subject macro block of encoding, as a reference picture.

Incidentally, the present embodiment shows the case in which a left eye image is used as a reference picture of a right eye image. However, when the right eye image is used as the reference picture of the left eye image, information on the motion vector is calculated by decreasing a distance in a horizontal direction of information on the parallax vector to a half, and adding an offset value corresponding to that the number of horizontal pixels of one picture is decreased to a half. Incidentally, when pixel accuracy is decreased to one fourth pixel or less by the conversion of information on the motion vector and the parallax vector, the motion vector and the parallax vector are converted by rounding up the pixel accuracy to one fourth pixel.

In this way, the parameter conversion unit 119 generates each encoding parameter of the macro block division type, the prediction mode, the motion vector and the reference picture of the subject macro block of encoding in the side-by-side image. The parameter conversion unit 119 also sets a slice type of a main view (left eye image) in multi-viewpoint moving image data, which corresponds to the side-by-side image, as a slice type of a picture including the subject macro block of encoding. An encoding direction determining unit 120 outputs the encoding parameter which is generated by the parameter conversion unit 119, as the encoding parameter of the subject macro block of encoding, in the transposing mode. The control unit 115 instructs a prediction encoding unit 121 to encode the subject macro block of encoding in accordance with the encoding parameter which is generated by the encoding method determining unit 120.

The prediction encoding unit 121 encodes the subject macro block of encoding, on the basis of the encoding parameter sent from the encoding method determining unit 120 (S807). When performing the intra-picture prediction, the prediction encoding unit 121 generates prediction error data between the data and the subject macro block of encoding on the same picture, in accordance with the determined prediction mode. In addition, when performing the inter-picture prediction, the prediction encoding unit 121 reads out the data of the reference picture from the memory 113, in accordance with the determined prediction mode, and generates prediction error data between the subject data of encoding and the reference data. Then, the prediction encoding unit 121 performs orthogonal transform processing to a designated pixel block unit. The prediction encoding unit 121 quantizes a conversion coefficient which is obtained by the orthogonal transform processing through a quantization step corresponding to the designated quantization parameter, and outputs the quantized data to the entropy encoding unit 122.

The prediction encoding unit 121 also performs inverse quantization processing and inverse orthogonal transform processing with respect to the quantized data, and adds the prediction data to the processed data to generate partially decoded data. Then, this partially decoded data is stored in the memory 113. The data which is stored in the memory 113 is used in the subsequent intra-picture prediction processing. Furthermore, the prediction encoding unit 121 performs deblocking filtering processing with respect to the partially decoded data, and then stores the processed data in the memory 113. The data which is stored in the memory 113 after the deblocking filtering processing is used in the subsequent inter-picture prediction processing.

The entropy encoding unit 122 performs entropy encoding processing by context adaptive variable length encoding (CAVLC) or context adaptive binary arithmetic encoding (CABAC) with respect to the input quantized data, and outputs the processed data to the memory 113.

The control unit 115 discriminates whether there is such an instruction from the operation unit 114 as to complete conversion processing or not (S808), and when there is such an instruction as to complete the conversion processing, the control unit 105 completes the processing. When there is not such an instruction as to complete the encoding, the process returns to S803, and then processing for the next macro block is continued.

Moving image data which is encoded in this way is stored in the memory 113 once. The output unit 117 outputs the encoded side-by-side image data to an external apparatus.

In addition, when the input multi-viewpoint image encoded data is encoded by the normal mode, the control unit 115 directs each unit to perform conversion processing according to the MPEG4 AVC method without using the encoding parameter of the multi-viewpoint image encoded data, in the conversion processing.

In this case, the image processing unit 118 generates the side-by-side image from the left eye moving image data and right eye moving image data stored in the memory 113, in the above described way. Then, the encoding method determining unit 120 sets 16×16 pixels and 8×8 pixels as the macro block division type of the intra-picture prediction, and 8×8 pixels and 4×4 pixels as the sub-macro block division type thereof. In addition, the encoding method determining unit 120 sets all of the macro block division types as the macro block division type of the inter-picture prediction, and all of the sub-macro block division types as the sub-macro block division type thereof.

Next, the encoding method determining unit 120 performs a simple intra-picture prediction and an inter-picture prediction processing including the motion compensation prediction or the parallax compensation prediction, and thereby calculates the evaluation value showing the encoding efficiency for each macro block. Then, the encoding method determining unit 120 determines the prediction mode on the basis of the slice type of the subject macro block of encoding and the calculated evaluation value. When the subject macro block of encoding is an I slice, the encoding method determining unit 120 selects a macro block division type having higher encoding efficiency, from the macro block division types of the intra-picture prediction. In addition, when the subject macro block of encoding is not the I slice, the encoding method determining unit 120 selects a prediction mode having higher encoding efficiency, from the intra-picture prediction or the inter-picture prediction. Then, the encoding method determining unit 120 selects a macro block division type corresponding to the selected prediction mode, from the macro block division types of the intra-picture prediction and the inter-picture prediction.

Next, the encoding method determining unit 120 determines an encoding parameter such as the slice type, the macro block division type, the prediction mode and the motion vector of the subject macro block of encoding. Then, the encoding method determining unit 120 sends the selected information on the encoding parameter such as the macro block division type, the reference picture, the prediction mode and the motion vector, to the prediction encoding unit 121.

The prediction encoding unit 121 subjects the prediction error data of the subject macro block of encoding to orthogonal transform processing, on the basis of the encoding parameter sent from the encoding method determining unit 120. The entropy encoding unit 122 performs the entropy encoding in the above described way, and the memory 113 stores the encoded data therein. When there is such an instruction as to end the conversion processing, the conversion processing is ended. The output unit 117 outputs the encoded side-by-side image data to an external apparatus.

Thus, in the first example of the present invention, the image processing apparatus controls the encoding of the multi-viewpoint moving image data so that the image processing apparatus can use the encoding parameter generated when the multi-viewpoint image is encoded according to the multi-viewpoint image encoding method, when encoding the data in accordance with MPEG4 AVC after having converted the multi-viewpoint moving image data into the data of the side-by-side method.

Thereby, the image processing apparatus can obtain an encoding parameter for encoding the side-by-side image, only by converting the encoding parameter of the multi-viewpoint moving image encoded data, in a decoding unit. In addition, the image processing apparatus can convert the moving image data encoded with the multi-viewpoint image encoding method, into the side-by-side image, efficiently at high speed.

Incidentally, in the present embodiment, the image processing system is configured so that the image processing apparatus 101 outputs the multi-viewpoint moving image encoded data which is encoded therein to the decoding apparatus, but is also configured so that a known recording apparatus records the multi-viewpoint moving image encoded data in a recording medium. In addition, in the present example, the image processing system is configured so that the image processing apparatus 111 inputs the multi-viewpoint moving image encoded data thereinto which is output from the image processing apparatus 101, but is also configured so that the image processing apparatus 111 reproduces the multi-viewpoint moving image encoded data which is recorded in the recording medium in the above described way.

### Second Embodiment

Next, a second exemplary embodiment will be described below. In the first example, a side-by-side image is generated from multi-viewpoint moving image data that is encoded once, and because of this, multi-viewpoint moving image encoded data needs to be subjected to decoding processing. However, it is considered to generate the side-by-side image from the input data and encode the side-by-side image while encoding the input multi-viewpoint moving image data, as a configuration of using an encoding parameter of the multi-viewpoint moving image data when encoding the side-by-side image. The second example provides a configuration for accomplishing the encoding of the multi-viewpoint moving image data, and the generation and encoding of the side-by-side image, by parallel processing.

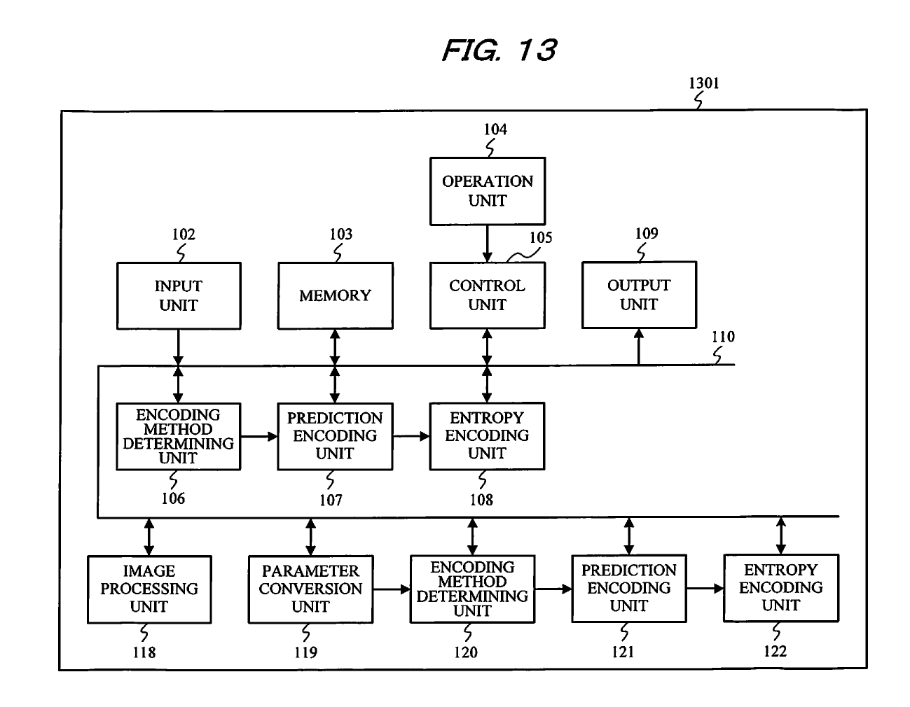

FIG. 13 is a view illustrating a configuration of an image processing apparatus 1301 according to the second example. In the image processing apparatus 1301, a configuration similar to that in FIG. 1 is designated by the same number. As is illustrated in the figure, the image processing apparatus 1301 of the present example has an encoding configuration in which the image processing apparatus 111 of the first example has encoded the side-by-side image. As is described above, an encoding method determining unit 120, a prediction encoding unit 121 and an entropy encoding unit 122 included in the encoding configuration have similar functions to those of an encoding method determining unit 106, a prediction encoding unit 107 and an entropy encoding unit 108. Each unit of these accomplishes the encoding according to the MPEG4 AVC method and the MPEG4 MVC method, under the control of a control unit 105.

The image processing apparatus 1301 encodes the multi-viewpoint moving image data including the right eye moving image data and the left eye moving image data in accordance with the multi-viewpoint image encoding method such as MPEG4 MVC, in a similar way to that in an image processing apparatus 101 of FIG. 1. The image processing apparatus 1301 also converts the input multi-viewpoint moving image data into the side-by-side image and then encodes the image in accordance with MPEG4 AVC, in a similar way to that of the image processing apparatus 111 of FIG. 1. In addition, the image processing apparatus 1301 performs the encoding of the multi-viewpoint moving image data according to MPEG4 MVC, and simultaneously performs the conversion of the input multi-viewpoint moving image data into the side-by-side image and the encoding of the multi-viewpoint moving image data in accordance with MPEG4 AVC, in parallel.

The image processing apparatus 1301 encodes the multi-viewpoint moving image data so that the image processing apparatus can use an encoding parameter which is encoded with a multi-viewpoint image encoding method, when encoding the side-by-side image in accordance with MPEG4 AVC, in parallel processing. Then, a parameter conversion unit 119 converts the encoding parameter which is used for encoding the multi-viewpoint moving image data, and thereby generates an encoding parameter of the side-by-side image, in the parallel processing.

When a user instruction of directing the parallel processing is input into an operation unit 104, after the encoding of the multi-viewpoint moving image data is started or while the encoding operation stops, the control unit 105 instructs each unit to encode the multi-viewpoint moving image data and perform the encoding processing of the side-by-side image. The encoding processing for the multi-viewpoint moving image data is performed in a similar way to that of FIGS. 6A and 6B. In addition, in the present example, the encoding method determining unit 106 sends information on an encoding parameter determined by S606, to the parameter conversion unit 119 in the parallel processing. However, the image processing apparatus may have a configuration in which the information is not sent to the parameter conversion unit 119 but is stored in a memory 103 and the parameter conversion unit 119 refers to the information.

In addition, an image processing unit 118 reads out a left eye image and a right eye image of the same time, from the left eye moving image data and right eye moving image data that are stored in the memory 103. The image processing unit 118 decreases the number of pixels in a horizontal direction in each of the read out image data to a half, combines the left eye image and the right eye image of which the pixel numbers are each reduced, and generates the side-by-side image. In addition, the parameter conversion unit 119 determines an encoding parameter of a subject macro block of encoding in the side-by-side image, on the basis of the information on an encoding parameter sent from the encoding method determining unit 106. The encoding processing for the side-by-side image is performed in a similar way to that of FIG. 8.

In the parallel processing, an output unit 109 outputs the multi-viewpoint moving image encoded data and the encoded data of the side-by-side image, to an external apparatus. On this occasion, the multi-viewpoint moving image encoded data and the encoded data of the side-by-side image can be output to different external apparatus from each other.

The image processing apparatus having the above described configuration of the second example can also convert the multi-viewpoint moving image data into the side-by-side image and encode the image efficiently and at high speed, in a similar way to that in the first example. Thereby, the encoded data of the side-by-side image corresponding to the multi-viewpoint moving image data can be provided also to an apparatus which cannot decode a moving image data which is encoded according to MPEG4 MVC.

Each unit constituting the recording apparatus and each step in the recording method according to the above described exemplary embodiment of the present invention can be achieved by the action of a program which is stored in a RAM, a ROM or the like of the computer. The present invention includes also this program, and a storage medium which has the above described program stored therein and can be read by a computer.

In addition, the present invention can provide an exemplary embodiment having a form of a system, an apparatus, a method, a program, a storage medium or the like, for instance. Specifically, the present invention may be applied to a system including a plurality of apparatuses, or may be applied to an apparatus including one apparatus.

Incidentally, the present invention also includes the case in which a program (program which corresponds to flow chart illustrated in FIG. 5 to FIG. 8 in exemplary embodiment) of a software which achieves a function of the above described exemplary embodiment is supplied directly or from a remote location to a system or an apparatus. The present invention also includes the case in which the function can be attained by such an action of the computer of the system or the apparatus to read out the above described supplied program code and execute the read out program code.

Accordingly, in order to achieve the functional processing of the present invention by the computer, the above described program code itself which is installed in the computer also achieves the present invention. In other words, the present invention includes also a computer program itself for achieving the function processing of the present invention. In this case, the present invention may be forms of a program which is executed by an object code or an interpreter, script data which is supplied to an operating system, and the like, as long as the forms have a function of the program.

Storage media for supplying the program therethrough include, for instance, a flexible disk, a hard disk, an optical disk and a magnetic optical disk. The storage media further include also an MO, a CD-ROM, a CD-R, a CD-RW, a magnetic tape, a nonvolatile memory card, a ROM and a DVD (DVD-ROM and DVD-R).

As for others, methods for supplying the program include a method of connecting a client computer to a home page of the Internet with the use of the browser of the computer. The program can be supplied by downloading the computer program itself of the present invention or a file which is compressed and includes an automatic installation function to a storage medium such as a hard disk, from the above described homepage.

In addition, the supply can also be achieved by dividing the program code which constitutes the program of the present invention into a plurality of files, and downloading the respective files from different home pages. In other words, the present invention also includes a WWW server which enables a plurality of users to download the program file for achieving the function processing of the present invention through the computer.

In addition, as for another method, the supply can also be achieved by encrypting the program of the present invention, storing the encrypted program in a storage medium such as a CD-ROM, distributing the resultant storage medium to the user, making a user who has cleared a predetermined condition to download key information that decrypts the encryption from a home page through the Internet, and making the user to execute the encrypted program by using the key information and install the program in the computer.

The above described function of the exemplary embodiment is achieved by making the computer execute the read out program. Furthermore, the above described function of the exemplary embodiment can also be achieved by the actual processing of which a part or all are performed by an OS that operates on the computer, on the basis of the direction of the program.

As for further another method, the above described function of the exemplary embodiment can also be achieved by the actual processing of which a part or all are performed by a CPU or the like provided in a function-expanded board that is inserted into the computer or a function-expanded unit connected to the computer, on the basis of the direction of the program which is firstly read out from the storage medium and is written in a memory provided in the function-expanded board or the function-expanded unit.

In the above, the present invention is described in detail on the basis of the exemplary embodiments, but the present invention is not limited to these particular exemplary embodiments, and various forms are also included in such a range as not to deviate from the scope of the invention.

While the present invention is described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2012-031815 filed on Feb. 16, 2012, which are hereby incorporated by reference herein in its entirety.

What is claimed is:

1. An image processing apparatus comprising:
a parameter generation unit configured to generate an encoding parameter for encoding, in accordance with a first encoding method, multi-viewpoint moving image data including left eye moving image data and right eye moving image data;
a first encoding unit configured to encode the multi-viewpoint moving image data using the encoding parameter generated by the parameter generation unit in accordance with the first encoding method; and
a control unit configured to control the parameter generation unit to generate an encoding parameter used for encoding the multi-viewpoint moving image data by the first encoding unit such that the encoding parameter used for encoding the multi-viewpoint moving image data can be used to encode, in accordance with a second encoding method different from the first encoding method, converted moving image data obtained by reducing the number of horizontal pixels in each of a left eye image and a right eye image in the multi-viewpoint moving image data and combining the left eye image and the right eye image, in each of which the number of pixels is reduced.

2. The image processing apparatus according to claim 1, further comprising a mode setting unit configured to set one of a plurality of modes including a first mode and a second mode, wherein in the first mode, the control unit controls the parameter generation unit to generate the encoding parameter such that the encoding parameter used for encoding the multi-viewpoint moving image data can be used for encoding the converted moving image data in accordance with the second encoding method, and in a second mode, the control unit does not perform the control in the first mode.

3. The image processing apparatus according to claim 2, wherein the control unit controls the generation of the encoding parameter by the parameter generation unit, in accordance with a combining method of the left eye image and the right eye image, in each of which the number of pixels is reduced, for the converted moving image data, in the first mode.

4. The image processing apparatus according to claim 2, further comprising an output unit configured to output the encoded multi-viewpoint moving image data, the encoding parameter generated by the parameter generation unit and mode information indicating the mode set by the mode setting unit.

5. The image processing apparatus according to claim 1, wherein the first encoding method and the second encoding method include prediction encoding which encodes difference between subject data of encoding and reference data, and the encoding parameter for encoding the multi-viewpoint moving image data includes a plurality of prediction modes in the prediction encoding.

6. The image processing apparatus according to claim 5, wherein the plurality of the prediction modes include intra-picture prediction, motion compensation prediction and parallax compensation prediction.

7. The image processing apparatus according to claim 6, wherein the first encoding unit performs encoding on the unit basis of a block including a predetermined number of pixels, and the control unit controls the parameter generation unit to set, on the unit basis of two adjacent blocks in a horizontal direction of the multi-viewpoint moving image data, prediction modes of the two blocks the same prediction mode.

8. The image processing apparatus according to claim 1, wherein the first encoding method and the second encoding method are methods which perform encoding on the unit basis of a block including a predetermined number of pixels, and can use any one type from a plurality of block division types each of which includes the predetermined number of the pixels, and the control unit controls the parameter generation unit to set, on the unit basis of two adjacent blocks in a horizontal direction of the multi-viewpoint moving image data, the block division types of the two blocks the same block division type.

9. The image processing apparatus according to claim 2, further comprising:
a decoding unit configured to decode the encoded multi-viewpoint moving image data encoded by the first encoding unit;
an image processing unit configured to reduce the number of horizontal pixels in each of a left eye image and a right eye image in the multi-viewpoint moving image data that is obtained by the decoding unit decoding the encoded multi-viewpoint moving image encoded data, and generates converted moving image data each picture of which is a combined image of the left eye image and the right eye image, in each of which the number of pixels is reduced; and
a parameter conversion unit configured to generate an encoding parameter for encoding, in accordance with the second encoding method, the converted moving image data generated by the image processing unit, by converting the encoding parameter generated by the parameter generation unit.

10. The image processing apparatus according to claim 9, wherein the parameter conversion unit generates an encoding parameter for encoding the converted moving image data by converting the encoding parameter generated by the parameter generation unit, if the encoded multi-viewpoint moving image data is encoded in the first mode, and generates an encoding parameter of the converted moving image data that is generated in the image processing unit, without using the encoding parameter generated by the parameter generation unit, if the encoded multi-viewpoint moving image data is encoded in the second mode.

11. The image processing apparatus according to claim 9, wherein the parameter conversion unit determines an encoding parameter of a target block in the converted moving image data, from the encoding parameter used for encoding adjacent two blocks in a horizontal direction in the encoded multi-viewpoint moving image data, which correspond to the target block, if the encoded multi-viewpoint moving image data is encoded in the first mode.

12. The image processing apparatus according to claim 1, further comprising:
an image processing unit configured to reduce the number of horizontal pixels in each of a left eye image and a right eye image in the multi-viewpoint moving image data, and generates converted moving image data each picture of which is a combined image of the left eye image and the right eye image, in each of which the number of pixels is reduced;
a parameter conversion unit configured to generate an encoding parameter for encoding, in accordance with the second encoding method, the converted moving image data generated by the image processing unit by converting the encoding parameter generated by the parameter generation unit; and
a second encoding unit configured to encode the converted moving image data in accordance with the second encoding method, by using the encoding parameter that generated by the parameter conversion unit.

13. The image processing apparatus according to claim 12, wherein the parameter conversion unit determines an encoding parameter of a target block in the converted moving image data, from the encoding parameter used for encoding adjacent two blocks in a horizontal direction in the multi-viewpoint moving image data, which correspond to the target block, if the multi-viewpoint moving image data is encoded in the first mode.

14. The image processing apparatus according to claim 12, wherein the control unit controls the first encoding unit and the second encoding unit such that encoding by the first encoding unit and encoding by the second encoding unit are performed in parallel.

15. A method for controlling an image processing apparatus that comprises a memory unit which stores multi-viewpoint moving image data including left eye moving image data and right eye moving image data therein, a parameter generation unit configured to generate an encoding parameter for encoding, in accordance with a first encoding method, the multi-viewpoint moving image data including left eye moving image data and right eye moving image data, stored in the memory unit, and a first encoding unit configured to encode the multi-viewpoint moving image data using the encoding parameter generated by the parameter generation unit in accordance with the first encoding method, comprising:
a control step of controlling the parameter generation unit to generate an encoding parameter used for encoding the multi-viewpoint moving image data by the first encoding unit such that the encoding parameter used for encoding the multi-viewpoint moving image data can be used to encode, in accordance with a second encoding method different from the first encoding method, converted moving image data obtained by reducing the number of horizontal pixels in each of a left eye image and a right eye image in the multi-viewpoint moving image data and combining the left eye image and the right eye image, in each of which the number of pixels is reduced.

16. A non-transitory computer-readable storage medium storing program code for causing a computer to control an image processing apparatus that comprises a memory unit configured to store multi-viewpoint moving image data including left eye moving image data and right eye moving image data therein, a parameter generation unit configured to generate an encoding parameter for encoding, in accordance with a first encoding method, the multi-viewpoint moving image data including left eye moving image data and right eye moving image data, stored in the memory unit, and a first encoding unit configured to encode the multi-viewpoint moving image data using the encoding parameter generated by the parameter generation unit in accordance with the first encoding method, comprising:
program code means for controlling the parameter generation unit to generate an encoding parameter used for encoding the multi-viewpoint moving image data by the first encoding unit such that the encoding parameter used for encoding the multi-viewpoint moving image data can be used to encode, in accordance with a second encoding method different from the first encoding method, converted moving image data obtained by reducing the number of horizontal pixels in each of a left eye image and a right eye image in the multi-viewpoint moving image data and combining the left eye image and the right eye image, in each of which the number of pixels is reduced.
